(19) United States
(12) Patent Application Publication
(10) Pub. No.: US 2007/0223315 A1
(43) Pub. Date: Sep. 27, 2007

(54) Article wrapped in a protective film

(76) Inventors: Jaques Andre, Annemasse (FR); Danielle Blomert, Geneva (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/728,114

(22) Filed: Mar. 22, 2007

Related U.S. Application Data
(60) Provisional application No. 60/784,717, filed on Mar. 22, 2006.

(51) Int. Cl. G04B 47/00

(52) U.S. Cl. 368/10

(57) ABSTRACT

An article such as wristwatch that has a contoured front face and a rear face that is generally flat or can be presented in a generally flat configuration can be intimately wrapped in a close-fitting transparent protective film of skin-wrapped plastics material. The wrapping extends continuously over the article's front face and is skin-wrapped to match the contour of the first or front face. It extends over the article's second rear face and has overlapping or non-overlapping edges on the rear face. It can remain essentially invisible so the wrapped object can be displayed as though it were unwrapped. It enables the wrapped article to be transported and handled without risk of being scratched or otherwise deteriorated and can be readily removed from the article when the need to protect its surface ceases.

This application claims priority to U.S. provisional application Ser. No. 60/784,717, filed Mar. 22, 2006, the entire disclosure of which is incorporated herein by reference.

The invention relates to objects or articles such as wristwatches that are typically handled during transportation, display and demonstration at points-of-sale and protection of the article outer appearance which may be deteriorated when the object is handled.

### BACKGROUND OF THE INVENTION

Objects or articles such as wristwatches are typically handled during transportation, display and demonstration at points-of-sale where they are shown to and handled by prospective purchasers. When the objects are handled their outer appearance is likely to be deteriorated for example by micro-scratching of the outer surface. For luxury watches or other objects made of soft precious metals like gold, even slight deterioration of the outer surface may render the object undesirable or unsaleable. As a result, many scratched or otherwise deteriorated luxury products are returned to the manufacturer for surface rehabilitation so they can be re-distributed for sale as new products.

U.S. Pat. No. 4,684,264 discloses a protective overlay made of a disc of transparent high static vinyl that could be non-adhesively stuck on a wristwatch crystal to prevent scratching or chipping. Such films have also been applied to protect the rear face of watchcases. This however does not offer any protection for the watchcase sides or the bracelet.

U.S. Pat. No. 4,495,254 and U.S. Pat. No. 4,533,605 disclose protecting precious metal articles with a permanent abrasion-resistant film of non-metallic glassy materials applied as a surface film by radio frequency (RF) sputtering techniques thereby requiring special surface treatments, and the treated articles may still be liable to deterioration when handled.

Various methods are known for packaging products under plastic. In “clamshell” packing, objects are placed in a cavity covered by a transparent plastic shell. This allows the objects to be placed on view for sale, and the object is released usually by the purchaser opening the plastic shell after purchase. Clamshell packing is in widespread use, but is not suitable for items like luxury wristwatches which are handled at the point of sale without being impeded by a plastic shell.

The stretch-pack method involves placing one or more objects on a support, and stretch-applying a film to cover the products and the support. This method is popular but would not serve as a reliable protection for wristwatches and luxury products.

Vacuum packing by the so-called “skin-pack” method is in widespread use for many items, and is described for example in US 2005/0199524-A1 for packaging perishable foods. In the skin-pack method, typically an object is placed on a porous backing sheet and is covered by a pre-heated film followed by the application of vacuum through the porous backing sheet, to firmly hold the film against the product and on the backing sheet. Alternatively, the product is placed between two vacuum-applied films with an optional frame of porous sheet material surrounding the product. Either way, the product is coated with a skin of the plastic film that adheres intimately to the product's surface.

The known skin-pack method is not suitable for packaging a wristwatch where the backing sheet or joined films and optional frame are cumbersome and undesirable for display and handling of the product at the point-of-sale.

There is therefore a need for protecting handleable objects like wristwatches against deterioration of their surface by scratching or otherwise during transportation, also when the object is displayed like a wristwatch on display in a shop window, and when the object is being handled at the point-of-sale, for example, by allowing a prospective purchaser to hold a wristwatch and place it on his or her wrist, without the protecting means interfering with the desired display or the handling of the object at the point-of-sale.

### SUMMARY OF THE INVENTION

The invention includes an article having coated thereon or wrapped therewith a film or transparent protective film.

The invention also includes a method comprising (a) applying a transparent protective film over and beyond the front face of an article; (b) skin-wrapping the film against the front face by the application of vacuum so that the film matches the contour of the front face, leaving side portions of the protective film that extend from the front face; and (c) folding the side portions of the transparent film to wrap the article in the film and to form overlapping or non-overlapping edges on the article's rear face.

Also included is a support for transmitting vacuum to a supported article for wrapping the article.

### BRIEF DESCRIPTION OF DRAWINGS

FIGS. 1A, 1B and 1C are respectively a side view, end view and top view of a wristwatch mounted on a special support in a first step of the method for wrapping the wristwatch;

FIGS. 2A and 2B are respectively a side view and end view of the wristwatch mounted on the support in a heat-applying second step of the method;

FIGS. 3A and 3B are respectively a side view and end view of the wristwatch, mounted on the support, pushed up against the heat-softened film in a third step of the method;

FIGS. 4A and 4B are respectively a side view and end view of the wristwatch mounted on the support in a vacuum-applying fourth step of the method;

FIGS. 5A and 5B are respectively a side view and end view of the wristwatch removed from the support in a fifth step of the method, after cutting-away of the film and cutting-away around the winding crown;

FIGS. 6A, 6B and 6C are respectively a side view, end view and top view of a wristwatch turned over and re-mounted on another special support in a sixth step of the method including cutting of the corners;

FIGS. 7A, 7B and 7C are respectively a side view, end view and top view of the turned-over wristwatch re-mounted on the other support in a heat- and vacuum applying seventh step of the method; and

FIGS. 8A and 8B are respectively a side view and end view of the turned-over wristwatch re-mounted on the other support in a pressure- and heat-applying eighth step of the method, FIG. 8C showing the rear of the finished wrapped wristwatch with its folded edges.

### DETAILED DESCRIPTION OF THE INVENTION

The article generally is a handleable article that has a contoured front face and a rear face that is generally or substantially flat or can be presented in a generally flat configuration. The article can be wrapped in a close-fitting transparent protective film of skin-wrapped plastics material that may (a) extend continuously over the article's front face and is skin-wrapped to match the contour of the front face; (b) extend over the article's rear face and has overlapping or non-overlapping edges on the rear face; (c) remain essentially invisible so the wrapped article can be displayed as though it were unwrapped; (d) enable the wrapped article to be transported and handled without risk of the article's surface being scratched or otherwise deteriorated; or (e) be readily removed from the article when the need to protect its surface ceases.

The article can for example be a watch such as wristwatch, a bracelet, a leather or leather-containing article, an article made of precious metal like a key-ring, a lighter or a medal, a jewelry item, or a mobile phone or communication device, or combinations of two or more thereof. The articles can be luxury products or non-luxury consumer products such as the afore-mentioned mobile phones where the flexible film could allow keypad keys to be actuated while remaining protected. In general, the articles can have outer faces of regular or irregular shapes to be protected against scratching and other deterioration, and that can be protected by the virtually-invisible skin-wrapped film; and a rear face that is generally or substantially flat or can be presented in a generally or substantially flat state (e.g., flexible bracelet strap) so it can be placed on a corresponding support for the application of vacuum. The overlapping or non-overlapping edges of the film on the article's rear face may be more visible, however without this being a drawback as the rear face is not normally on view when the article is used.

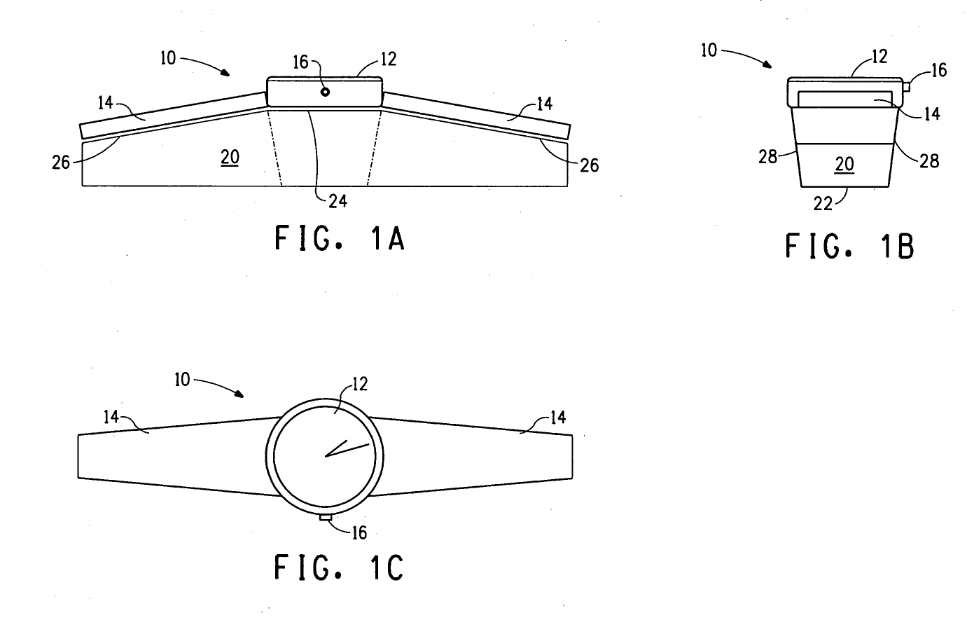

FIGS. 1A and 1B show a wristwatch 10 mounted on a first support 20 in a first step of the wrapping method. The wristwatch 10 has a watchcase 12 having a bracelet 14 in two parts that can be joined together. The watch 10 has a front face shown in FIG. 1C and the watchcase has the usual winding crown 16 on one side. The illustrated watchcase 12 is typically made of or coated with precious metal like gold, and has for example a round shape. The bracelet 14 can be of leather, metal or a linked construction; it has the usual end clasps or other closure device, not shown. Parts of the watchcase 12 and bracelet 14 may be adorned with precious stones. The outer face of the watch or bracelet typically has polished parts liable to be deteriorated by scratching etc.

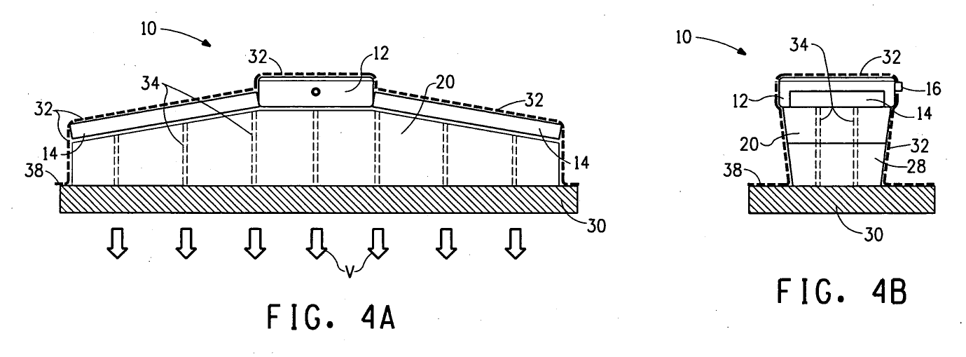

The support 20 has a shape corresponding to that of the watch 10 to be wrapped. It has a flat bottom 22 and a top surface for supporting the watch 10, namely with a flat central part 24 that supports the underside of the watchcase 12 and two downwardly-sloping top side parts 26 supporting the bracelet 14. The support also has side walls 28 whose surfaces taper longitudinally in concordance with the bracelet 14 and in side section as shown in FIG. 1B. The support 20 is made of vacuum-transmitting material or can have perforations 34 (see FIGS. 4A and 4B) for transmitting vacuum to its top face.

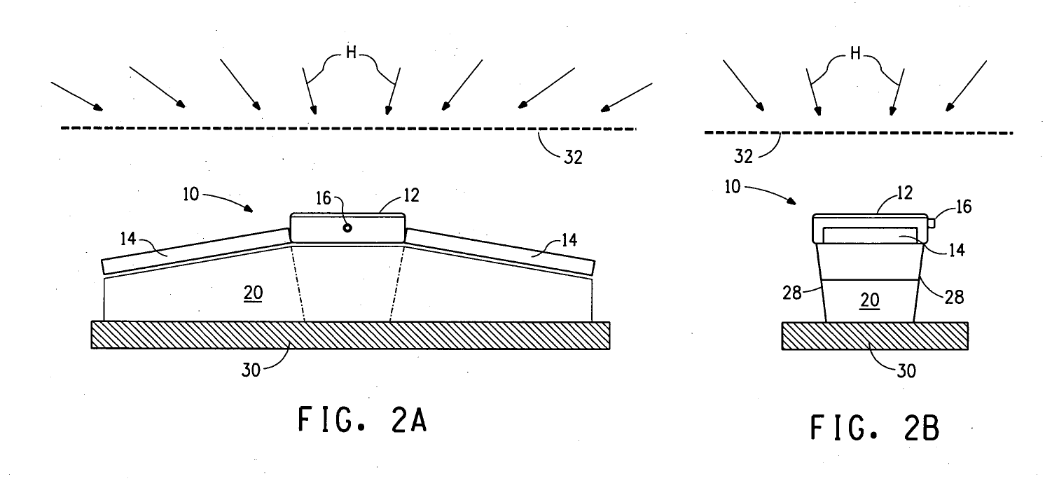

The watch 10 mounted on support 20 is then placed in a commercial skin-wrap machine, on a vacuum-application sheet or board 30 of the machine, as shown in FIG. 2A. In known manner, a film 32 of protective plastics material is brought above the watch 10 and heat H applied from a heat-source above the film 32. The applied heat is adjusted so that it softens the film 32 that begins to sag over the watch 10.

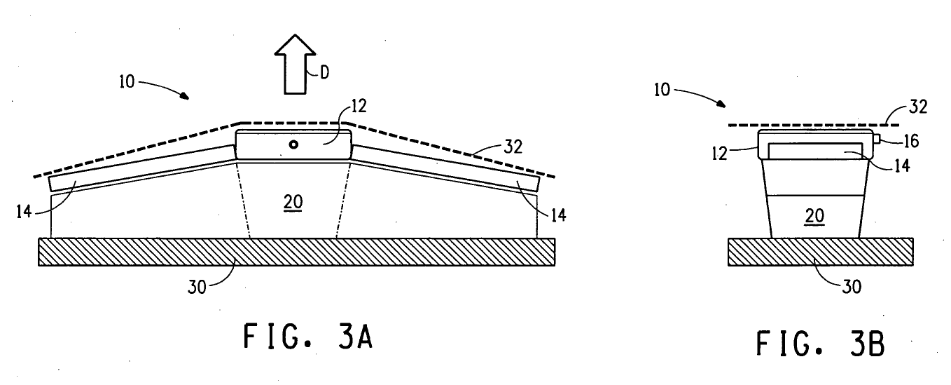

The sheet 30 with support 20 and watch 10 is then lifted in direction D, FIG. 3A, to bring the softened film 32 into contact with the top of the watch 10, as shown in FIGS. 3A and 3B.

Vacuum V is then applied from below the sheet 30, FIG. 4A. The vacuum acts through the sheet 30 and through a series of perforations 34 in support 20, so that the vacuum acts on the underside of the film 32 and sucks this film 32 into contact with the upper face of watch 10 and also over the side faces 28 of support 20, with edge parts 38 of film 32 applied against the upper face of sheet 30.

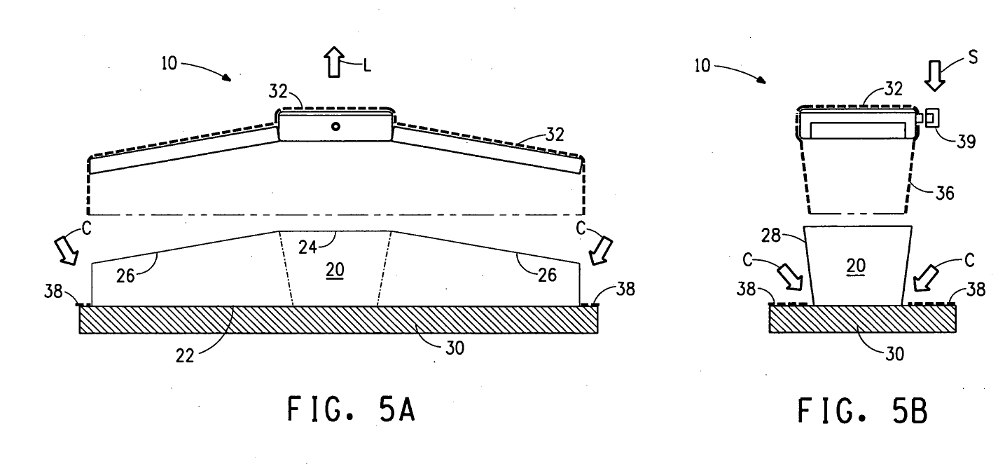

The edge parts 38 of the film are then cut at C, FIG. 5A, allowing the watch 10 to be lifted off as indicated by arrow L. At this stage, the watch 10 is coated on its upper face by the vacuum-applied film 32 which is extended by downwardly-directed sections 36 of the film corresponding to the walls of support 20, and the underneath part of watch 10 remains uncoated. The dimensions of the side walls 28 can be chosen to form folded-over flaps of desired size corresponding to the size of the watch 10 or other article being wrapped; this size of the flaps can be determined by making the height of the walls 28 in proportion to the width of the article 10 being wrapped. In the given example of a tapered watch bracelet 14, the height of walls 28 along the bracelet 14 decreases correspondingly.

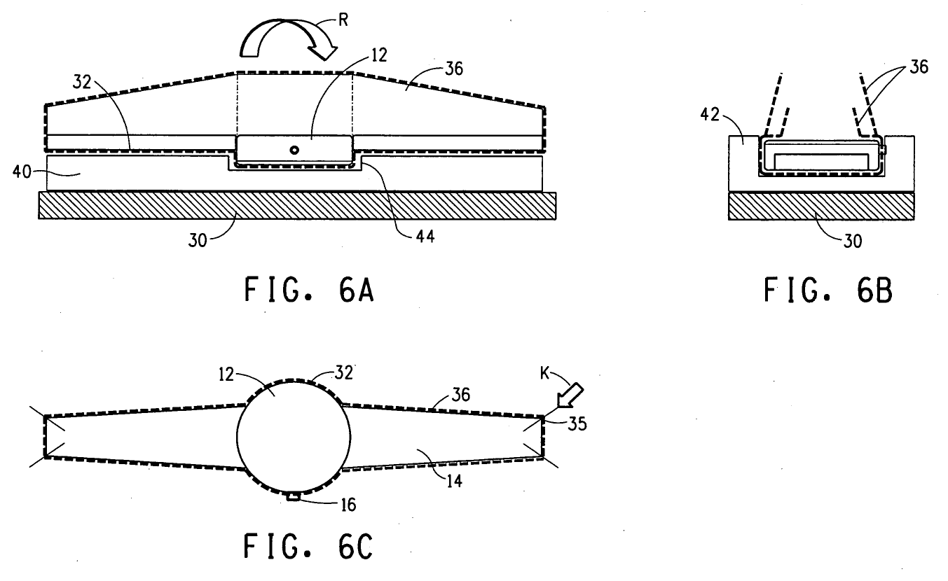

The watch 10 with its surface film 32 extended by the sections 36 is then turned over as indicated by arrow R in FIG. 6A, and its coated front face is placed in a second support 40 on the vacuum-application sheet 30 of the skin-wrap machine. As shown in FIGS. 6A and 6B, support 40 has side walls 42 and a central recess 44 for accommodating the front face of the watchcase 12. The watch 10 is supported upside down in this support 40 with the film sections 36 now protruding upwards with the free top ends inclined towards the center, as shown in FIG. 6B. This inclination of the sections 36 self-forms as a result of the inclination of the sidewalls 28 of support 20.

FIG. 6C (also 7C) shows the rear side of watch 10 before it is covered; also indicated are four cuts 35 at the four corners of the upwardly-protruding film 36, and formed by the application of a knife schematically shown as arrow K. These four cuts 35 separate the film sections 38 into a series of flaps that will be folded down in the next step.

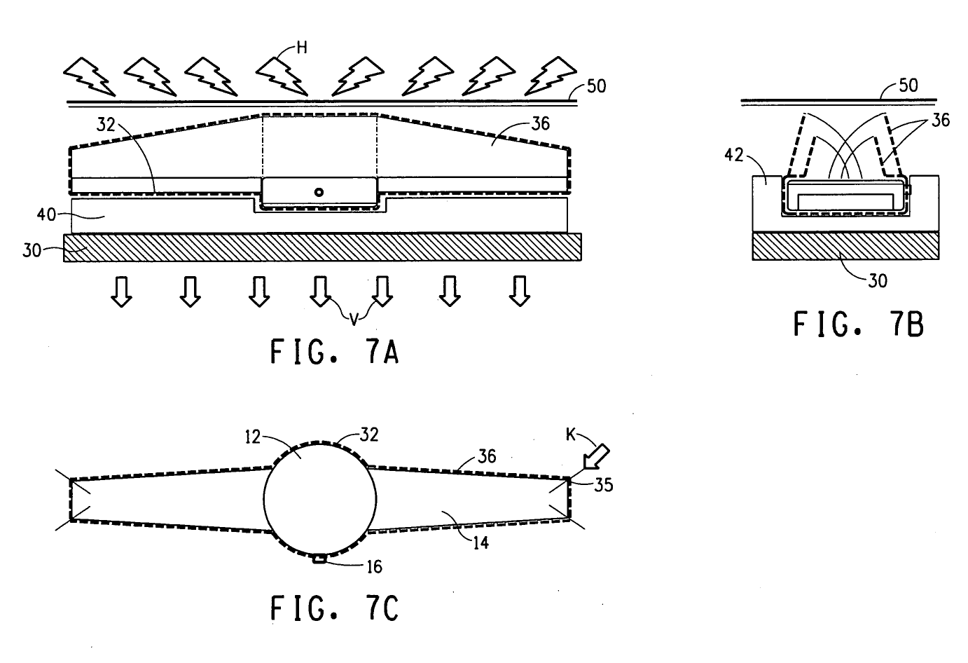

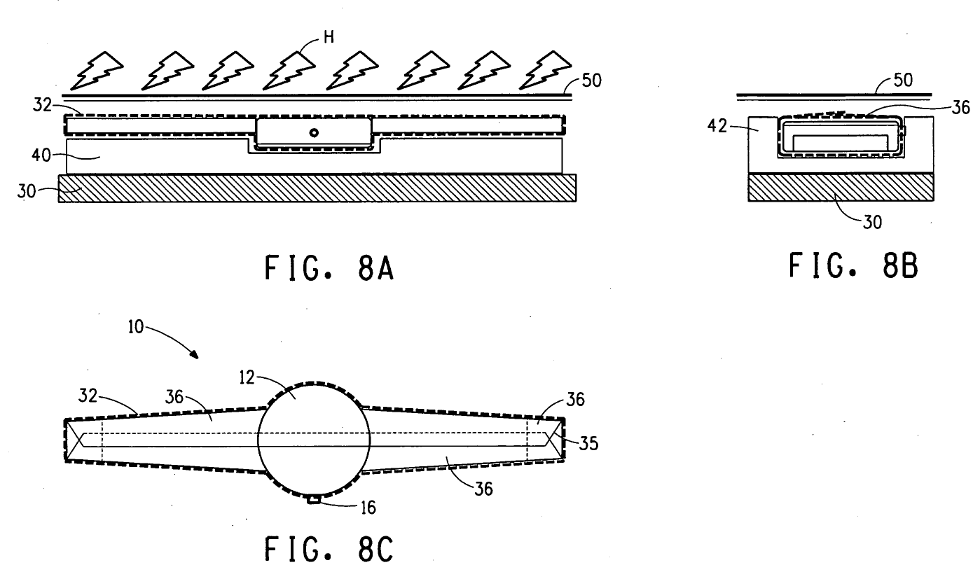

A heat-resistant film 50 is then applied over the top of the watch 10 on its support 40, and heat and vacuum are applied as indicated at H and V. The heating combined with the vacuum initially causes the inclined film sections/flaps 36 to gently collapse inwardly as indicated in FIG. 7B whereupon the watch 10 and support 40 are lifted by means of the sheet 30 to complete the folding operation as indicated in FIG. 8B, preferably with the application of heat as indicated by H in FIG. 8a, and optionally with applied pressure on the heat-resistant film 50 to firmly form overlapping edges of the sections 36 on the rear face of the watch, as indicated in FIG. 8C.

When the watch 10 or another article is wrapped in this way, the protective film 32 extends continuously over the watches front face and is skin-wrapped to match the contour of the front face, following closely the surface profile of the watch and bracelet even if this is intricate. The film 32 extends also over the watches rear face and has overlapping edges on the rear face as shown in FIG. 8C. Alternatively these edges could be non-overlapping, for instance with an extra sheet interposed. The wrapped film 32 remains essentially invisible from the front of the watch so the wrapped watch 10/32 can be displayed as though it were unwrapped and it enables the wrapped watch 10/32 to be transported and handled without risk of the front surface being scratched or otherwise deteriorated. The wrapped film 32 forms a practically invisible and flexible envelope around the watch 10, enabling the bracelet 14 to be opened and closed, so a potential user can try on the watch 10 while it remains wrapped. Lastly, the film 32 can be readily removed from the watch 10 when the need to protect its surface ceases, for instance after the watch has been sold and the owner takes possession.

If it is desired to have access is to the winding-crown 16 (or more generally to any function control member) while the watch remains wrapped, it is possible to cut away the skin-wrapped film around the winding crown or function control member, to allow access, as indicated schematically by arrow S in FIG. 5B. To assist this cutting away and to avoid any scratching/damage, the winding crown can be covered with a disc of plastic (for example PTFE) which, as indicated at 39 in FIG. 5B, can be removed with the corresponding part of the film 32, or separately.

Optionally, a pull-strip can be included in the overlapping edges of the film on the rear of the watch 10 to facilitate later removal of the film when desired.

For any given article to be wrapped, in the illustrated example, a wristwatch, the first support 20 and the second support 40 will have their shape and dimensions adapted to the shape and dimensions of the particular article, and the same supports can be used multiple times for wrapping the same articles. The supports can have flat or recessed parts to accommodate articles of different shapes.

Preferably, as shown in FIG. 1A, the different sidewalls 28 of support 20 are inclined at different angles so that the corresponding sections 36 of the film are at different angles to facilitate orderly folding of the flaps as indicated in FIGS. 7B and 8B.

The film 32 of protective material can be chosen from materials which combine transparency, surface hardness, puncture resistance, abrasion resistance, flexibility, and/or heat-forming properties. Such materials can include acid copolymers, ionomers, and metallocene polyethylene (mPE).

Acid copolymers comprise repeat units derived from ethylene and an α, β-unsaturated C₃-C₈ carboxylic acid including acrylic acid and methacrylic acid. For example, “ethylene methacrylic acid (EMM)” means a copolymer of ethylene (E) and methacrylic acid (MAA); “ethylene acrylic acid (EM)” means a copolymer of ethylene and acrylic acid (EM). Acid copolymers are well known to one skilled in the art such as commercially available Nucrel® from E. I. du Pont de Nemours and Company, Wilmington, Del., USA (DuPont).

An ionomer can be an acid copolymer whose carboxylic acid groups or a portion thereof are neutralized with one or metal cations such as sodium, zinc, lithium, magnesium, calcium, or combinations of two or more thereof. An ionomer can have about 10 to about 99.9%, about 10 to about 70%, or about 35 to about 70% of its carboxylic acid groups neutralized. Ionomers and their methods of manufacture are well known to one skilled in the art such as that disclosed in U.S. Pat. No. 3,264,272. Commercial ionomer includes Surlyn® from DuPont or Lotek® from the Exxon Chemical Company (Exxon). Ionomers can have solid-state properties characteristic of cross-linked polymers and melt-fabricability properties characteristic of uncrosslinked thermoplastic polymers and are widely used in packaging and are known for their scratch-resistance properties.

Optionally, film 32 is a multilayer film whose inner layer in contact with the watch 10 or other article has non wet look properties. Such multilayer resins are commercially available such as Surlyn® NWL from DuPont. Such films can avoid the formation of a “mottled” appearance on glossy surfaces. Film 32 can also be an ethylene polymer. The term “ethylene polymer”, as used herein, refers to any polymer comprising greater than 50 mole % of —CH₂CH₂— repeat units derived from an ethylene monomer or comonomer.

Ethylene polymers can include any ethylene-containing polymers within the definition set forth above, whether homopolymers or copolymers. Examples include, but are not limited to, ethylene homopolymers and ethylene interpolymers, such as low density polyethylene (LDPE), heterogeneously branched ethylene/α-olefin interpolymer (e.g., linear low density polyethylene (LLDPE), ultra low density polyethylene (ULDPE), substantially linear ethylene polymers (SLEP)), and homogeneously branched ethylene polymers. A further example of ethylene polymers is ethylene vinyl acetate copolymers (EVA), based on copolymerization products of ethylene with vinyl acetate.

Unsaturated comonomers useful for polymerizing with ethylene to form ethylene polymers include, for example, ethylenically unsaturated monomers, conjugated or non-conjugated dienes, polyenes, and the like. Examples of comonomers include, without limitation, α,β ethylenically unsaturated carboxylic acids, such as C₃ to C₈ α,β ethylenically unsaturated carboxylic acids; ester derivatives of α,β ethylenically unsaturated carboxylic acids, such as straight-chained or branched C₃ to C₂₀ alkyl esters or C₁ to C₈ straight-chained or branched alkyl esters.

Other comonomers include straight-chained or branched C₃ to C₂₀ α-olefins such as propylene, isobutylene, 1-butene, 1-hexene, 1-pentene, 4-methyl-1-pentene, 1-heptene, 1-octene, 1-nonene, 1-decene, styrene, halo- or alkyl-substituted styrenes, tetrafluoroethylene, vinylbenzocyclobutane, 1,4-hexadiene, 1,7-octadiene; and cycloalkenes, e.g., cyclopentene, cyclohexene and cyclooctene; vinyl acetate; combinations of two or more thereof; and the like.

Ethylene copolymer used herein refers to that comprising repeat units derived from ethylene and an unsaturated carboxylic acid or ester thereof such as (meth) acrylic acid or C₁ to C₈ alkyl (meth)acrylate, or combinations of two or more thereof. The term “(meth)acrylic” or “(meth)acrylate”, refers to acrylic and/or methacrylic or to alkyl acrylate and/or alkyl methacrylate. Examples of alkyl (meth)acrylates include methyl acrylate, ethyl acrylate and butyl acrylate. For example, “ethylene/methyl acrylate (EMA)” means a copolymer of ethylene and methyl acrylate (MA); “ethylene/ethyl acrylate (EEA)” means a copolymer of ethylene and ethyl acrylate (EA); “ethylene/butyl acrylate (EBA)” means a copolymer of ethylene and butyl acrylate (BA); and combinations of two or more thereof. Examples of more than one comonomer are also included. For example “ethylene/isobutyl acrylate methacrylic acid (E/iBA/MAA)” means a terpolymer of ethylene, iso-butyl acrylate (iBA) and methacrylic acid (MAA).

Alkyl (meth) acrylic acid or alkyl (meth)acrylate comonomer incorporated into ethylene copolymer can vary from 0.01 or 5 up to as high as 40 weight % of the total copolymer or even higher such as from 5 to 30, or 10 to 25, weight %.

Ethylene copolymer can also include another comonomer such as carbon monoxide, glycidyl acrylate, glycidyl methacrylate, and glycidyl vinyl ether, or combinations of two or more thereof.

Ethylene copolymers can be produced by processes well known in the polymer art using either autoclave or tubular reactors. The copolymerization can be run as a continuous process in an autoclave as disclosed in U.S. Pat. Nos. 3,264,272; 4,351,931; 4,248,990; and 5,028,674.

Ethylene copolymers are commercially available such as Elvaloy® and Elvax® from DuPont, Exact® from Exxon, Tafiner® from the Mitsui Petrochemical Corporation, Affinity® and Engage® from Dow Chemical Company.

The above-disclosed copolymers can vary in molecular weight as witnessed by melt index numerically in terms of a fraction up to about 10 such as about 4.3 to about 8 g/10 min.

The polymers may optionally further comprise additives such as thermal and ultraviolet (UV) stabilizers, UV absorbers, antistatic agents, processing aids, fluorescent whitening agents, pigments, lubricants, etc. These conventional ingredients may be present in the compositions used in this invention in quantities that are generally from 0.01 to 20, or 0.1 to 15, weight percent.

The optional incorporation of additives can be carried out by any known process such as, for example, by dry blending, by extruding a mixture of the various constituents, by the conventional masterbatch technique, or the like.

The protected film can be a single layer or multilayer film comprising one or more of the above disclosed polymers. A film layer produced from or comprising an ionomer generally is clear or transparent.

Any methods known to one skilled in the art can be used for wrapping or coating an article in a close-fitting transparent protective film of skin-wrapped plastics material. Applying a film over an article can be carried out by any means known to one skilled in the art such as, for example, dipping the article in or brushing or coating or spraying the article with, a film solution that is made from one or more of the polymers disclosed above.

The method included in the invention can comprise (a) applying a substantially transparent protective film over and beyond the front face of an article; (b) vacuum skin packaging the film; and (c) folding the side portions of the transparent film to wrap the article in the film and to form overlapping or non-overlapping edges on the article's second or rear face.

Vacuum skin packaging includes skin-wrapping the film against the first or front face by the application of vacuum so that the film matches the contour of the first or front face, leaving side portions of the protective film that extend from the first or front face.

Process for making a film can be cast, extruded, co-extruded, laminated, or the like, including orientation (either uniaxially or biaxially) by various methods as is well known to one skilled in the art. For example, it can involve laying down a molten curtain of the polymer or blends of polymers moving at speed from about 100 to about 1000, or about 300 to about 800, feet per as they come into contact with a cold roll. The melt curtain can be formed by extruding the polymer(s) through a flat die. The temperature of the ethylene copolymer composition as it leaves the die can be between about 300 and 340° C., or about 310 to about 330° C. The air gap between the die exit and cold roll is typically about 3 to 15, or about 5 to about 10, inches.

The film can be unoriented, oriented in a uniaxial direction (e.g. machine direction), or oriented in a biaxial direction (e.g. machine direction and transverse direction). The film can be biaxially oriented by drawing in two mutually perpendicular directions in the plane of the film to achieve a satisfactory combination of mechanical and physical properties. See, e.g., U.S. Pat. Nos. 3,278,663; 3,337,665; 3,456,044; 4,590,106; 4,760,116; 4,769,421; 4,797,235 and 4,886,634. Because the processes for making different films are well known to one skilled in the art, the description of which is omitted herein for the interest of brevity.

The films may be treated by means of corona discharge, ozone or other means standard in the industry. The film is laminated to a metallized film substrate using an ethylene copolymer composition as an adhesive layer to provide a multilayer structure. The adhesion of the multilayer structure can be improved by increasing the thickness of the ethylene copolymer layer. The thickness of the ethylene/alkyl acrylate layer can be about 10 to about 40μ (0.4 mil to 1.6 mil), or about 15 to about 30μ (0.6 to 1.2 mil) thick.

For example, one or two film webs, which can be individual sheets of film and be identical or different, can be used. The film can be softened for easy application. In two webs, one web can be clear (transparent) for the top of the article, allowing visualization of the packaged goods and the other can be opaque and/or colored to provide a background or both webs can be clear. One or both of the webs may also be printed with designs, logos, alphanumeric text to provide a pleasing appearance for the package and/or to provide information to the consumer. A single web of film can also be folded onto itself to provide two overlying webs, or a tube of film may be formed such that two overlying portions of the tube provide the equivalent of two webs of film.

The article to be packaged can be placed between the two webs, vacuum applied to the package, and a seal formed by adhering such as heat sealing the perimeters of the two webs together. The process of sealing the perimeter of the package can be any process such as by heat sealing two film webs indirectly through the use of an intervening third polymeric film, or any process that may be developed for forming a sealed package. The application of vacuum is preceded by applying heat to soften the film.

Also included is a support for transmitting vacuum to a supported article for skin-wrapping the article in a close-fitting transparent protective film of plastics material, the support can comprise a body of vacuum-transmitting material having a flat bottom for placing over a source of vacuum, a top for supporting an object to be skin-wrapped, and side walls for supporting side portions of the film that extend over the side walls of the support after the application of vacuum, the side walls being so dimensioned that the corresponding side portions of the film that extend over the side walls can be wrapped around the object after the object has been removed from the support.

The support can be perforated or made of material allowing a vacuum to be applied to the article's second or rear face.

The method disclosed above can be used for wrapping articles or objects of different shapes and dimensions, wherein for each object of given shape and dimensions, a corresponding support is used. When using at least one support that comprises a central part, top walls can extend with a longitudinal taper and a slight downward incline from either side of the central part, and side walls matching the taper of the top walls and whose height decreases towards the ends of the top walls. The top of the central part of the support can be flat or recessed.

Steps (a) and (b) disclosed above can be carried out with the article's second or rear face placed on a support which approximately matches the shape of the object's rear and front faces, the support having side walls for supporting side portions of the film that extend over the side walls of the support at the end of step (b). Step (b) is followed if necessary by cutting the film to form side portions of desired dimensions; and the folding of step (c) is carried out after removing the object from the support. Step (c) can be carried out by applying vacuum or with the application of pressure through a removable sheet.

1. An article having coated thereon or wrapped therewith a film wherein the article includes watch, bracelet, leather or leather-containing article, article made of precious metal, lighter, medal, jewelry item, mobile phone or communication device, or combinations of two or more thereof; the film comprises or is produced from ionomer, ethylene polymer, ethylene copolymer, or combinations of two or more thereof; the ethylene polymer comprises repeat unit derived from ethylene; the ethylene copolymer includes an ethylene acid copolymer and comprises repeat units derived from ethylene and one or more comonomers; the comonomer includes α,β-unsaturated C₃-C₈ carboxylic acid, C₃ to C₂₀ alkyl ester, C₁ to C₈ alkyl ester, C₃ to C₂₀ α-olefin, or combinations of two or more thereof; and the ionomer is derived from the acid copolymer wherein about 1 to about 99.9% of the carboxylic acid is neutralized with one or more metal cations.

2. The article of claim 1 wherein the article is a handleable object having a contoured front face and a generally flat rear face, the object is wrapped in a film which is a close-fitting transparent protective film of skin-wrapped plastics material that (a) extends continuously over the article's front face and is skin-wrapped to match the contour of the front face; (b) extends over the object's rear face and has overlapping or non-overlapping edges on the rear face; (c) remains essentially invisible so the article can be displayed as though it were unwrapped; (d) enables the article to be transported and handled without risk of the object's surface being scratched or otherwise deteriorated; and (e) is capable of being readily removed from the object when the need to protect its surface ceases.

3. The article of claim 1 wherein the article has a protruding function-control member, the film is cut-away to allow access to the function-control member, and the film on the article's rear face includes a pull-off strip to facilitate removal of the film.

4. The article of claim 2 wherein the article has a protruding function-control member, the film is cut-away to allow access to the function-control member, and the film on the article's rear face includes a pull-off strip to facilitate removal of the film.

5. The article of claim 3 wherein the film is a multilayer film and the inner layer of the film in contact with the object has non wet look properties.

6. The article of claim 4 wherein the film is a multilayer film and the inner layer of the film in contact with the object has non wet look properties.

7. The article of claim 1 wherein the article is the watch, bracelet, leather or leather-containing article, article made of precious metal, lighter, medal, jewelry item, mobile phone or communication device, or combinations of two or more thereof.

8. The article of claim 7 wherein the article has a protruding function-control member, the film is cut-away to allow access to the function-control member, and the film on the article's rear face includes a pull-off strip to facilitate removal of the film.

9. The article of claim 8 wherein the film is a multilayer film and the inner layer of the film in contact with the object has non wet look properties.

10. A method comprising (a) applying a film over and beyond an article's front face; (b) vacuum skin packaging the article; (b1) optionally cutting the film to form side portions of desired dimensions; and (c) folding, optionally with vacuum or with the application of pressure through a removable sheet, the side portions of the film to wrap the object in the film and to form overlapping or non-overlapping edges on the article's second face wherein
the article includes watch, bracelet, leather or leather-containing article, article made of precious metal, lighter, medal, jewelry item, mobile phone or communication device, or combinations of two or more thereof;
the film comprises or is produced from ionomer, ethylene polymer, ethylene copolymer, or combinations of two or more thereof; the ethylene polymer comprises repeat unit derived from ethylene;
the ethylene copolymer includes an ethylene acid copolymer and comprises repeat units derived from ethylene and one or more comonomers; the comonomer includes α,β-unsaturated C₃-C₈ carboxylic acid, C₃ to C₂₀ alkyl ester, C₁ to C₈ alkyl ester, C₃ to C₂₀ α-olefin, or combinations of two or more thereof;
the ionomer is derived from the acid copolymer wherein about 1 to about 99.9% of the carboxylic acid is neutralized with one or more metal cations; and
the vacuum skin packaging includes skin-wrapping the film against the front face by application of vacuum thereby matching the film with the contour of the first face and leaving side portions of the film extending from the front face.

11. The method of claim 10 wherein step (a) and step (b) are carried out with the article's rear face placed on a support which approximately matches the shape of the article's rear and front faces; the support has side walls for supporting side portions of the film that extend over the side walls of the support at the end of step (b); and the folding in step (c) is carried out after removing the object from the support.

12. The method of claim 11 further comprising step (b1).

13. The method of claim 10 wherein the support comprises a central part, top walls extending with a longitudinal taper and a slight downward incline from either side of the central part, and side walls matching the taper of the top walls and whose height decreases towards the ends of the top walls.

14. The method of claim 13 wherein step (a) and step (b) are carried out with the article's rear face placed on a support which approximately matches the shape of the article's rear and front faces; the support has side walls for supporting side portions of the film that extend over the side walls of the support at the end of step (b); and the folding in step (c) is carried out after removing the object from the support.

15. The method of claim 14 further comprising step (b1) and different support is used for article having different shapes and dimensions, wherein for each article of given shape and dimensions, a corresponding support is used; optionally the top of the central part of the support is flat or recessed.

16. The method of claim 14 wherein the support is perforated or is made of material allowing a vacuum to be applied to the article's rear face.

17. The method of claim 14 wherein the application of vacuum is preceded by applying heat to soften the film.

18. The method of claim 14 wherein the film is a multilayer film and the inner layer of the film in contact with the article has non wet look properties.

19. A support for transmitting vacuum for vacuum skin packaging or wrapping an article comprising a body of vacuum-transmitting material having a flat bottom for placing over a source of vacuum, a top for supporting an object to be packaged, and side walls for supporting side portions of the film that extend over the side walls of the support after the application of vacuum, the side walls being so dimensioned that the corresponding side portions of the film that extend over the side walls are capable of being wrapped around the article after the article has been removed from the support wherein the top of the support is optionally larger than the flat bottom of the support and the side walls inline from the large top to the smaller bottom.
